(19) United States
(12) Patent Application Publication
(10) Pub. No.: US 2010/0082225 A1
(43) Pub. Date: Apr. 1, 2010

(54) SYSTEM AND PROCESS FOR ADAPTING VEHICLE EMISSIONS TO SURROUNDING POLLUTION LEVEL: THE "GREEN COMPLIANCE MODULE"

(75) Inventors: Isabelle Bournel, Cagnes sur mer (FR); Vincent Tassy, Cagnes sur mer (FR)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/323,560

(22) Filed: Nov. 26, 2008

(30) Foreign Application Priority Data
Sep. 30, 2008 (FR) EPO08035620.0

(51) Int. Cl. G06F 19/00

(52) U.S. Cl. 701/115

(57) ABSTRACT

A process for modulating a vehicle's engine function in response to local pollution levels is described, as is a control unit specifically designed to implement the process. The process controller is referred to as the Green Compliance Module (“GCM”), which is integrated into the vehicle's wireless communication system. After receiving the wireless messages containing locality-specific pollution data and the applicable locality-specific threshold it is sent to the GCM. The GCM determines (i.e., calculates) the difference, if any, between the current pollution and/or engine emission levels and the applicable threshold values. The result of this calculation determines whether the vehicle's mechanical components, i.e., organs, will continue to operate normally or are either collectively or selectively modulated in order to decrease the vehicle's contribution of fuel emissions to the local pollution conditions.

### CROSS REFERENCE TO RELATED APPLICATION

This application is related to and claims priority of commonly-owned, co-pending European Patent Application No. EP08035620.0 filed on Sep. 30, 2008, the contents and disclosure of which is expressly incorporated by reference in its entirety.

### FIELD OF THE INVENTION

The invention relates to a system and process for automatically responding to wireless messages containing locality-specific pollution data, wherein the response comprises regulating the operation of motor vehicle systems and components known to emit pollutants associated with fuel consumption.

### BACKGROUND OF THE INVENTION

It is known that pollution levels vary quantitatively and qualitatively from locale to locale, depending on factors such, as e.g., population density, concentration of industrial sites, the proximity of transportation hubs, and the like. Motor vehicle traffic can also be a major contributor to environmental pollution as fuel emissions are released into the environment as a result of fuel consumption. In the case of motor vehicle emissions there are several undesirable and/or unhealthy by-products of fuel consumption that appear in the ambient atmosphere. The major pollutants identified in fuel emissions include a heterogeneous group of nitrogen oxides and sulfur oxides, particulate matter that may be mixed with aromatic aryl hydrocarbons (i.e., known carcinogens), carbon monoxide and other volatile hydrocarbons.

From a quantitative perspective, emissions can vary locally with the time of day, e.g., pre-dawn versus morning rush hour. In addition, the emissions often vary with specific locations such as downtown areas, traffic hubs, bridge and tunnel entrances, as well as common traffic backups on streets and highways on one hand, and residential areas on the other. These temporal and geographical variables leading to variation of emissions level are most often encountered in populated areas with a spectrum of localities having different levels of different types of activity. Thus, constant emissions monitoring at a given locality, especially those with significant industry and motor vehicle traffic, are likely to yield emission (or pollution) peaks and valleys, such that it would be desirable to be able to automatically regulate mobile vehicle emissions at a particular locale and within a specific time frame when such regulation is desirable.

The current approach to informing the operator of a motor vehicle that the local emissions levels are such that he or she should comply by, e.g., adapting their speed to current local conditions, shifting gears, turning off the air conditioning, and the like, is mediated by road signs, radio traffic reports or on-board navigation systems. However, complying with these warnings is voluntary because it is based on the free will of the vehicle operator. Further, the vehicle operator may not be knowledgeable enough to know what vehicle functions to modify and to what level. Therefore, enforcing environmental guidelines is not an efficient process. Therefore, there is a need to provide systems for automatically implementing vehicle fuel emissions compliance, wherein at least partial compliance is optionally rendered mandatory through direct modification of the engine management system.

### SUMMARY OF THE INVENTION

It is one aspect of the present invention to provide an in-vehicle computer response system for receiving and analyzing pollution information from a wireless communication/information center. It is preferred that the information be locality-specific, although this preference does not limit the size (i.e., area) of any specific location. Further, the environmental data is preferably pollution data, and should include motor vehicle fuel emissions data. The message may contain a locality's current pollution data or level and the applicable threshold(s).

An additional aspect of the present invention is to provide an in-vehicle system to process the pollution information data which is referred to herein as the Green Compliance Module (GCM), which in turn regulates the controllers of various engine components and/or systems whose functioning contributes to production of fuel emissions. The engine functions regulated by the GCM are preferably those that effectively modify the amount of at least one pollutant within the vehicle's emissions.

The need for implementing vehicle emissions compliance as described above is effectively addressed by a process mediated, in part, by an in-vehicle system comprising a wireless receiver capable of receiving wireless transmissions from a traffic/environmental information center. The process comprises a process for automatically complying with vehicle pollution/emissions information received from a remote information center, the process comprising the steps of;
(a) receiving a wireless message containing locality-specific pollution data;
(b) delivering the message to a controller referred to as a green compliance module (GCM) implemented by a vehicle processor device and/or control system that identifies and interprets the locality-specific pollution data in the message;
(c) preparing operating instructions for one or more relevant vehicle organs; and
(d) sending an operating instruction from the GCM to said one or more organs effecting vehicle emissions, wherein the organ is instructed to either operate in first mode or in second mode.

In additional embodiments of the process, it is contemplated that each organ registers with the GCM upon vehicle initiation and proceeds to enter the normal mode of operation. The time period of operation in the normal mode may continue unabated during the period the wireless system is acquiring or waits to acquire more current or updated pollution information.

In other embodiments of the process, it is contemplated that each specific organ is instructed by the vehicle control system to operate in the same mode as all of the other specific organs. In effect, the totality of GCM-registered specific organs is regulated collectively. However, in even further embodiments, it is contemplated that the process of the present invention individually assesses each specific organ and independently instructs each organ to operate in either the normal mode or the green mode.

In an even further additional embodiment of the specific operating instruction sent by the GCM to a specific organ is determined by whether or not at least one total pollution level or at least one single pollutant level included in the wireless message is equal to or greater than a corresponding locality-specific threshold level contained in the message. This embodiment contemplates that when the specific operating instruction sent by the GCM to a specific organ is equal to or greater than a corresponding locality-specific threshold level, at least one organ is instructed to switch to green mode.

It is also contemplated that the GCM may fine tune the down-regulation of the organs in green mode, by specifically calculating the magnitude of the excess of pollution above the applicable threshold. It would be desirable for an embodiment of the process to have graded levels of the green mode operability. In this way, the GCM can then devise a proportionate down-regulation of the relevant organs depending on the environmental urgency reflected in the amount of excess pollution.

In another embodiment, the functions of the GCM may be performed by the traffic/pollution center. In such an embodiment, the vehicle receives a wireless message from the traffic/pollution information center comprising organ-specific operating instructions based on locality-specific pollution information that is analyzed prior to transmission. This embodiment of the present invention is realized by the following process for automatically modulating a vehicle's fuel emission-related activities comprising:
(a) an information center transmitting a wireless message comprising organ-specific and locality-specific information;
(b) a vehicle receiver receiving the wireless message; and
(c) delivering the message from the vehicle's computer system to a multiplexing bus that identifies and distributes organ-specific information instructing one or more specific organs to either continue operating in either a first mode or switch to a second mode.

### BRIEF DESCRIPTION OF THE DRAWING

FIG. 1 is a schematic diagram illustrating one non-limiting embodiment of a system for use in complying with time-sensitive and location-specific fuel emissions information provided by an information center to a motor vehicle.

FIG. 2 provides a non-limiting example of a data structure used for the wireless messages transmitted by the traffic/pollution information center.

FIG. 3 is a flow-chart illustrating a non-limiting embodiment of a process for processing an updated pollution data report that includes fuel emissions data.

FIG. 4 is a flow-chart illustrating a non-limiting embodiment of a series of processing steps performed by the automatic compliance module.

FIG. 5 illustrates the process of acquiring and storing the pollution and emission information by the GCM.

FIG. 6 illustrates the iterative process for switching all of the registered vehicle organs to normal operation mode after initialization.

FIG. 7 illustrates the iterative process for switching all of the registered organs to Green operation mode.

FIG. 8 illustrates the listing of vehicle organs and relevant information in the exemplified the table of operations.

### DETAILED DESCRIPTION OF THE INVENTION

For the purpose of this description the term “organ” refers to a part of a vehicle that performs a function, and preferably a function that impacts on engine emissions. Thus, an organ may be a multi-component system and may or may not be an actual component of the engine. For example, the air conditioning unit (“A/C”) is known to effect fuel emissions produced by a vehicle; however the A/C is not part of the engine. Organs may include other vehicle emission control devices including but not limited to: electronically operated devices such as the air pump (which is belt-driven to supply air to the exhaust system); carburetor controls to provide air-fuel ratio adjustments and includes an electric choke; Exhaust Gas Re-circulation (EGR) system that re-circulates burned exhaust gases back into the engine's intake manifold; and the dual-bed or three way microcomputer controlled catalytic converter device.

The term Green Compliance Module, i.e., GCM, refers to the controller executed at the vehicle and by a vehicle processor device (“CPC”) or like controller module that receives and interprets the incoming wireless pollution data and determines which vehicle organ to contact and in which mode the contacted organ should operate; a first, e.g., normal mode or a second, e.g., green mode. Persons of ordinary skill in the art will appreciate that the term “normal mode” comprises a broad scope of operating levels. In some instances, the normal mode may encompass characteristics of the green mode as, e.g., some people drive slowly, do not like A/C, etc. Therefore, the most encompassing and accurate definition of the normal mode is any level of vehicle organ operation attainable in the absence of down-regulating instructions from the GCM.

The term “green” as used in the term Green Compliance Module merely refers in a general manner to the environmental concerns underlying the GCM's implementation, in view of “green” being a popular generic reference to environmentally beneficial or restorative innovations. The term “green” is not meant to specify any connection to any official governmental, administrative or organizational environmental entities. The term “green” in GCM merely acknowledges the desirability to diminish pollution levels. In this context, the GCM functions to modulate engine emissions by down-regulating in a controlled manner the functioning of one or more vehicle organs. Therefore, as used herein, the mode of organ function referred to as “green mode,” is any mode of operation that is down-regulated from the normal mode in response to the pollution-related instructions from the GCM. Thus, operating in green mode does not necessarily encompass one set of operating conditions for the vehicle. The scope of green mode operations can be appreciated by considering that the GCM makes decisions and executes its orders automatically, without the vehicle operator's input.

It is contemplated that the GCM interacts not only with the engine but with other equipment and accessories. Therefore, in one embodiment the GCM is implemented as a sub-program of the computer-controlled engine system, but it also provides input to it like other organs via a multiplexing bus. In modern vehicles generally, there is not only one on-board computer systems, but two on board computers. One is generally dedicated to managing the engine, and the other one deals with all of the computer controlled equipment and accessories, thus the GCM module would likely be part of the former. Although the GCM could be incorporated into the second, or general, computer system it is more likely to be implemented as a standalone device.

The term “pollution” refers to the pollutants that can be measured in the atmosphere. The term pollution is somewhat broader than the term “emissions” which are meant to reflect those pollutants produced directly from the consumption of fuel by the vehicle. Thus, emissions are a subset of the total pollution in a local area, especially in an industrial area or in the vicinity of a major transportation hub that may be located outside of a populated area. Thus, the process of the present invention encompasses employing embodiments of the GCM that can take into consideration non-vehicular pollutants in determining the level of modulation required by the GCM.

The term “down-regulation” or “down-regulating” refers to the fact that when the local pollution levels are too high, the GCM adjusts the functioning of at least one organ in order to produce less and/or fewer emissions. The GCM is constitutively switching organ function between normal mode and green mode depending on the pollution data it receives. For the purpose of this description, the normal mode of operation of a vehicle organ is the mode wherein the GCM is not down-regulating any of the relevant vehicle organs. In the green mode at least one organ is instructed to automatically decrease its output so as to use less fuel and produce a lower level of emissions.

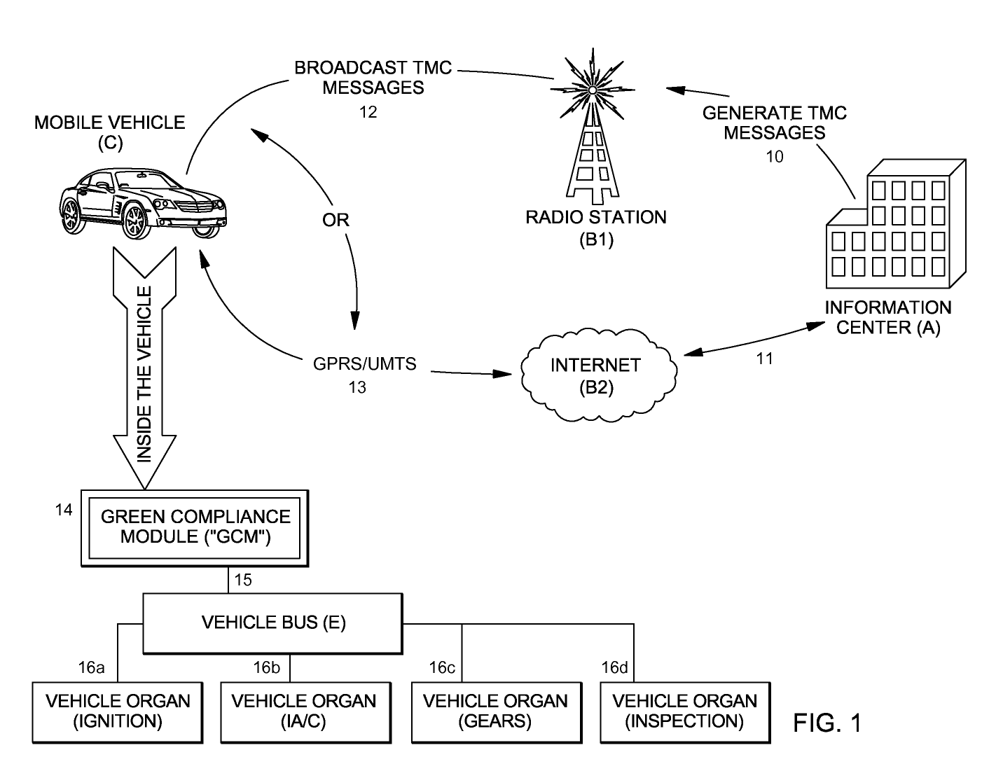

FIG. 1 illustrates overall system architecture in which the in-vehicle automatic GCM of the present invention is employed. Wireless signals originate from an information center, e.g., a traffic information center and are transmitted in at least two ways. For example, the pollution data may be sent as a Traffic Message Channel (“TMC”) 10, which is a technology developed specifically for delivering traffic and travel information to drivers. It is typically digitally coded using the Radio Data System (“RDS”) system on conventional FM radio broadcasts (B1) 12. It can also be transmitted according to DAB (“DIGITAL AUDIO BROADCAST”) or satellite radio communication standards. Alternatively, as indicated in (B2), the information may be transmitted by a wireless internet packet-oriented data service 11, e.g., the General Packet Radio Service (“GPRS”) or the third generation broadband Universal Mobile Telecommunications System (“UMTS”) 13. The information may be transmitted to the vehicle receiver (C) by any mechanism—a satellite, a wireless tower, a terrestrial radio, or the transmitter function of another vehicle's radio receiver (i.e., transceiver).

FIG. 1. further illustrates the automatic GCM system 14 built-into a vehicle that provides an on-board system for regulating vehicle emissions in real time. The emission regulating process operates through the Green Compliance (“GCM”). As illustrated in FIG. 1 the on-board system, i.e., the GCM 14 obtains current/updated pollution data and acceptable threshold levels from the TMC or like traffic information transmissions received from traffic information providers. The vehicle (C) receives the information through a receiver system, e.g., 12 and/or 13, preferably a wireless transceiver or receiver system that can capture data transmitted in several data formats. Upon receiving the data, the GCM processor executes programmed instructions for comparing current levels of the generalized level of vehicle emissions with the relevant locality's threshold levels. The instructions are sent to a vehicle bus (E), which in turn distributes the instructions to one or more vehicle organs, steps 16a-d.

In the present invention the wireless pollution/emission data received is an itemized list of specific emission components, i.e., listing each pollutant individually. This may be especially useful in instances where a particular engine function contributes disproportionately to a particular emission. The wireless pollution report comprises at least two sets of information; (a) a specific pollutant's threshold in the specific locality, i.e., a part of the “situation element” shown in the figure, and (b) the current or updated data for that pollutant in the specific locality, which is another aspect of the situation element. Additional formats may provide data based on a broader categorization, e.g., total vehicle-emission based pollution threshold level for a particular locality, and that locality's current total vehicle-emission based pollution level.

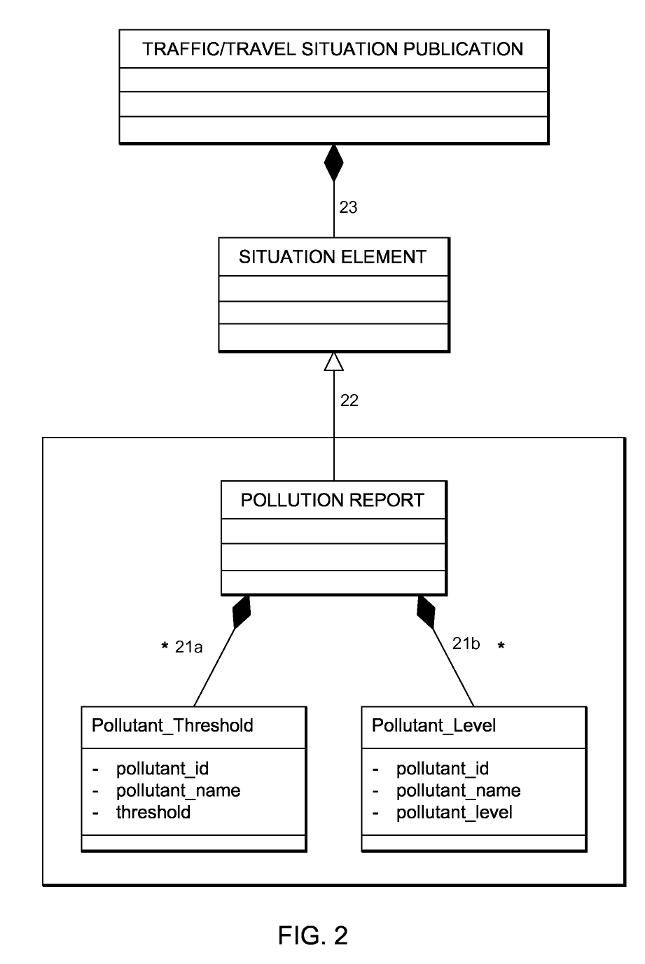

If it is assumed that the transport of the messages will be based on currently existing standards, e.g., ALERT-C and DATEX, it is reasonable to expect that an extra class would be added to the data model so that the pollution information will be relevant to a particular real-world situation. Accordingly, the data format of the message may be in various forms, one of which is illustrated in FIG. 2. The two components of the report comprise the locality-specific pollutant threshold 21a and the current level 21b of that pollutant 21b. Thus, in one embodiment of the data format, a single pollution report comprises the acceptable threshold level 21a of only one pollutant as well as the current updated level of the pollutant (or class of similar or structurally related pollutants) in the locality. In instances where more than one pollutant is relevant to the vehicle's engine function within a specific locality, the final broadcasted report can be a composite of the of the individual pollution reports for each relevant pollutant. The one or more pollution reports are pooled or merged (i.e., via step 22), which forms the foundation for the data to be broadcast by the traffic center.

In an embodiment of the reporting process, the two types of data, i.e., 21a and 21b may be associated within the same pollution report as in the preceding illustration. Alternatively, the pollutant threshold, 21a, may be independently transmitted and stored in the G(CM. In such an embodiment, only the updated current pollution data is transmitted, and compared to the threshold value stored in memory. This may be effective in cases, for example, the first time a vehicle enters a locality. The vehicle's first pollution report may contain the aggregate of both sets of data, i.e., 21a and 21b, whereas on subsequent trips to that locality, only 21b will be transmitted, unless there is a newer pollutant-specific threshold to be transmitted to the GCM to replace the out-of-date threshold(s).

One function of the GCM is to determine (i.e., calculate) the difference, if any, between the current emission levels and the applicable threshold values. The result of this calculation determines whether the vehicle's mechanical components, i.e., organs, will continue to operate normally or are either collectively or selectively modulated in order to decrease the vehicle's fuel emissions. The resulting decision may be an “all-or-none” response or a graded response. For example, the GCM may automatically initiate down regulation, control override, interrupt or completely shut-down an organ, e.g., the air conditioning of the vehicle, whereas the vehicles engine and/or electronic gearbox may be automatically instructed to operate but, in one embodiment is modulated to reduce the engine's RPMs (“revolutions per minute”). Similarly, the ignition map or the fuel injection map or both, may also be down-regulated to reduce emissions.

In FIG. 1, a vehicle first goes through an initialization period when it is started. During the initialization period all vehicle organs that impact on engine fuel emissions register themselves with the GCM via a data multiplexing bus. The organs provide the GCM with each organ's different emission levels at different modes of operation. The G(CM further “listens” or polls various pollution and fuel emissions data in the form of wireless messages, and compares them to the locality's thresholds. When the emissions level is greater than or equal to an established threshold, the GCM switches the vehicle organs to down-regulated operation mode that will result in less total emission generally, or less of a particular emission.

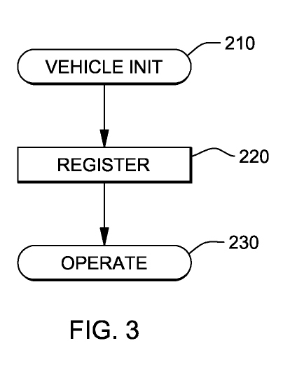

The process executed by the vehicles processor or controller device to control the vehicle organs is shown in the flowchart illustrated in FIG. 3. As indicated above, the overall process begins during the initialization (step 210) of the vehicle organs, which is followed by the registration of the organ with the GCM through the vehicle's multiplexing data bus. Once registration (step 220) is performed, the organ begins normal operation (step 230).

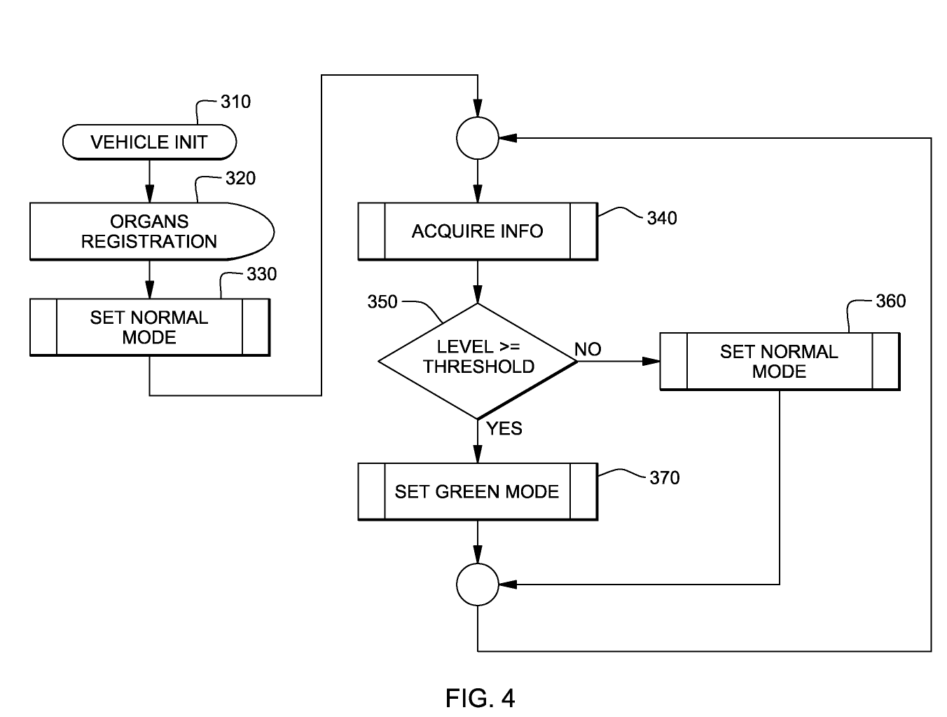

FIGS. 4 provides an overview of the steps in the process of the present invention. Steps 310 to 330 reiterate the organ initialization and registration process shown in FIG. 4, except that in step 330 the organs operate, at least initially in normal mode; i.e., the GCM has not down-regulated the organs' performance. Thus, for example, each of the abovementioned organs, including electronically controlled devices impacting the vehicle's emissions, i.e., air-pump, carburetor controls, choke valve, EGR system components and catalytic converter elements are all initialized and set to the normal mode of operation initially. The GCM receives pollution and fuel emissions data (step 340) that is sent from the vehicle's wireless receiver after receiving the wireless message from a traffic and/or environmental information center. The GCM compares this updated information with the applicable threshold levels of the pollutants and emissions in the particular locality to which the data relates. The threshold information may accompany the pollution level updates. Alternatively, if no threshold data arrives with the message, the GCM may execute the relevant comparison, i.e., calculation, on the most recently stored relevant threshold values.

The GCM determines if for at least one particular pollutant or emission component, or the collective general level of pollution or emissions, whether the data received is equal to or greater than the local relevant thresholds (step 350). Based on this result, the GCM determines whether to allow the vehicle's organs to continue in normal mode (step 360 by determining N for “no”) or whether to switch to the green mode (step 370 by determining Y, for “yes”) wherein one or more vehicle organs are down-regulated.

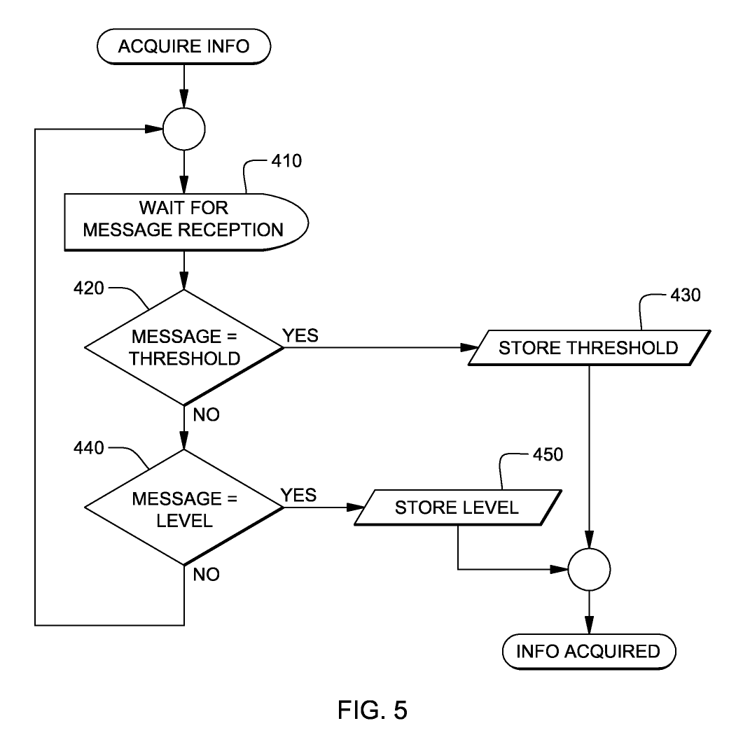

The process of acquiring the pollution and emission information is illustrated in FIG. 5. The process described herein contemplates the use of various wireless systems. A non-limiting list of such communication protocols includes TMC, RDS, IP over GPRS, UMTS, and communication and telematic protocols, or EDGE, and the like. The system waits for a new pollution/emission related message (step 410) and transmitted to the GCM. The GCM implements programmed instructions to pause the message and extract relevant data and determines whether the message contains information relating to local pollution thresholds (step 420) and stores the information in a local memory cell (step 430), e.g., a cache or vehicle on-board memory storage devices. The message is further checked for current existing pollution levels (step 440) and stored in the memory (step 450).

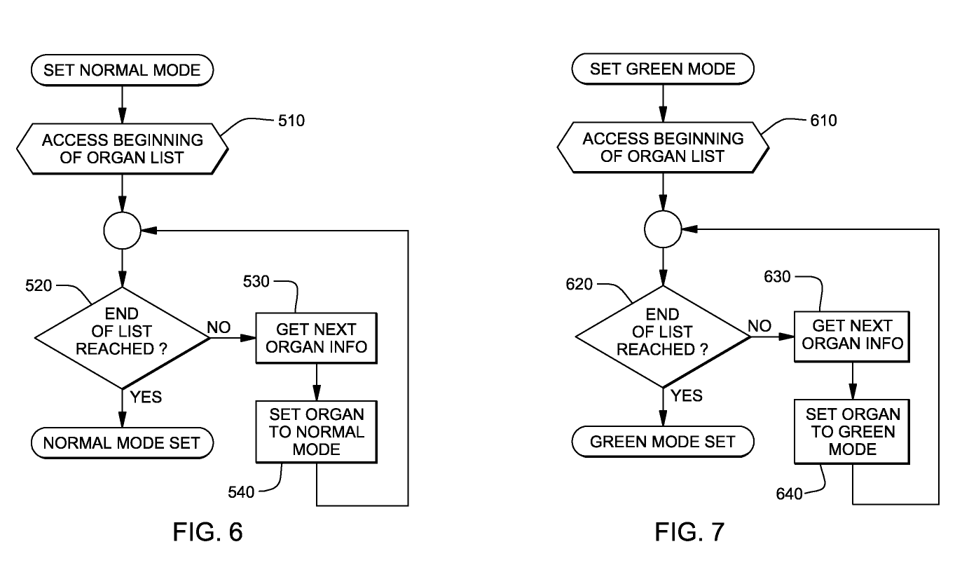

FIG. 6 illustrates the iterative process executed to switch all of the registered vehicle organs to normal operation mode after initialization and after the unacceptably high local pollution and emission levels again reach or fall below the acceptable thresholds of the locality in which the vehicle is operating. Step 510 represents the preparatory state of the GCM prior to beginning checking of the registered organ list as described in FIG. 7. The process of querying the vehicle organs for their relevant data continues as a recurrent loop beginning with step 520 when the answer is “N,” the loop further comprising steps 530-540. When all of the organs on the list have been queried (step 520 with “Y” answer) the GCM instructs the listed organs to switch to normal mode by sending the appropriate operation instruction and normal mode value to the appropriate address on the multiplexing bus as described in FIG. 7.

FIG. 7 illustrates the iterative process for switching all of the registered organs to Green operation mode. Step 610 is the point in memory right before the beginning of the registered organ list as described in FIG. 7. Step 620 begins an iterative loop of steps wherein the GCM checks whether the there are any remaining organ entries (step 630) after the current pointer location, until all selected organs are placed in Green mode (Step 640) which will be indicated by step 620 with the answer “Y.” An organ is switched to Green mode by sending the appropriate operation instruction and normal mode value to the appropriate address on the multiplexing bus as described in FIG. 7. For instance, one or more of the following “Green” mode adjustments for down-regulating vehicle emissions may include sending appropriate electronic control signals to one or more organs including, but not limited to: the air pump, for example, to switch or divert air to different parts of the exhaust system or the atmosphere; the carburetor, to adjust the air-fuel mixture ratio or adjusting the time the choke valve is closed; the EGR operation; the catalytic converters that require a supply of air from the air pump, which may be further controlled by the vehicle's microcomputer; or the electronic ignition system, e.g., to adjust the vehicle's ignition timing.

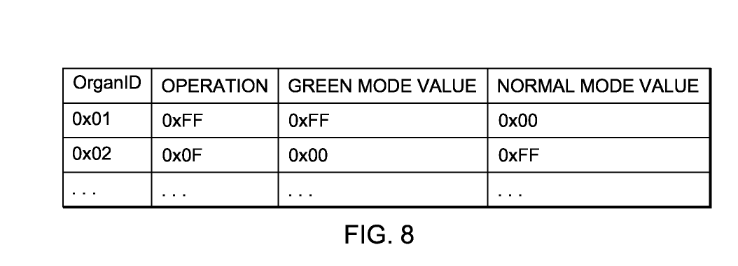

The listing of vehicle organs is exemplified in the table of operations illustrated in FIG. 8. As specified, each organ is provided with an identifier code as well as code indicating whether the organ is to perform its particular function after switching to normal mode or green mode. It is noted that the code exemplified in FIG. 8 is an arbitrary illustration intended to provide a context for how the data may be formatted and stored in the GCM. In the relevant marketplace the nature the code is likely to vary considerably among competing manufacturers, therefore persons of ordinary skill in the art will appreciate that the table of operations presented in FIG. 8. is for illustrative purposes only.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded into a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus, the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to affect one or more functions of this invention. Furthermore, the present invention may be implemented as a program storage device readable by machine, tangibly embodying a program of instructions executable by the machine to perform method steps for causing one or more functions of this invention.

What is claimed is:

1. A process for automatically modulating a vehicle's fuel emission-related activities, the process comprising;
(a) receiving a wireless message containing locality-specific pollution data;
(b) delivering the message to a controller referred to as a green compliance module (GCM) implemented by a vehicle processor device and/or control system that identifies and interprets the locality-specific pollution data in the message;
(c) preparing operating instructions for one or more relevant vehicle organs; and
(d) sending an operating instruction from the GCM to said one or more organs effecting vehicle emissions, wherein the organ is instructed to either operate in first mode or in second mode.

2. The process of claim 1, wherein the one or more wireless messages are analyzed for locality-specific pollution data

3. The process of claim 1, wherein interpreting the locality-specific pollution data comprises deciding whether or not a particular organ will operate in first mode or second mode.

4. The process of claim 3, wherein the first mode is the normal mode and the second mode is the green mode.

5. The process of claim 2, wherein the locality-specific pollution data comprises the total level of pollution and/or, an itemized listing of individual pollutant levels.

6. The process of claim 1, wherein each organ registers with the GCM upon vehicle initiation and proceeds to enter the normal mode of operation until the GCM analyzes pollution data contained in a newly received wireless message.

7. The process of claim 1, wherein each specific organ is instructed to operate in the same mode as all of the other organs.

8. The process of claim 1, wherein each specific organ is individually instructed to independently operate in either normal mode or green mode.

9. The process of claim 1, wherein the specific operating instruction sent by the GCM to a specific organ is determined by whether or not at least one total pollution level or at least one single pollutant level contained in the wireless message is equal to or greater than a corresponding locality-specific threshold level contained in the message.

10. The process of claim 9, wherein when the at least one total pollution level or at least one single pollutant level is equal to or greater than a corresponding locality-specific threshold level, the GCM instructs one or more organs to operate in green mode.

11. The process of claim 1, wherein if the GCM identifies locality-specific pollution data in the wireless message, the locality-specific pollution data is stored in a local memory cell.

12. The process of claim 1, wherein if the GCM identifies threshold pollution data in the wireless message, the threshold data is stored in a local memory cell.

13. A computer program product for automatically modulating a vehicle's fuel emission-related activities, the computer program comprising a computer readable medium having computer usable program code embodied therewith, the computer usable program code comprising;
(a) computer usable code configured to receive a wireless message containing locality-specific pollution data;
(b) computer usable code configured to deliver the message to a controller referred to as a green compliance module (GCM) implemented by a vehicle processor device and/or control system that identifies and interprets the locality-specific pollution data in the message;
(c) computer usable code configured to prepare operating instructions for one or more relevant vehicle organs; and
(d) computer usable code configured to send an operating instruction from the GCM to said one or more organs effecting vehicle emissions, wherein the organ is instructed to either operate in first mode or in second mode.

14. The computer program product of claim 13 wherein the computer usable code is configured to analyze a wireless message for locality-specific pollution data.

15. The computer program product of claim 14 wherein the computer usable code is configured to identify at least one locality-specific current level of a pollutant.

16. The computer program product of claim 15 wherein the computer usable code is further configured to identify the pollutant's locality-specific threshold, and to further determine whether the locality-specific current level of the pollutant is equal to or greater than the locality-specific threshold of the pollutant.

17. The computer program product of claim 16 wherein the computer usable code is configured to instruct a vehicle organ to switch the organ's mode of operation.

18. A system for automatically modulating a vehicle's fuel emission-related activities, the system comprising;
(a) an on-board receiving device for receiving a wireless message containing locality-specific pollution data;
(b) a processing device responsive to said received message for extracting said locality specific pollution data and determining whether or not a particular vehicle organ operates in a first normal operating mode or a second reduced emission operating mode;
(c) said processing device generating one or more messages suitable for controlling respective one or more vehicle organ's mode of operation; and,
(d) a vehicle bus for forwarding said controlling message to one or more vehicle organs.

19. The system of claim 18 wherein the processing device further comprises:
a processor for determining whether or not a particular vehicle organ operates in a first normal operating mode or a second reduced emission operating mode, wherein if the current level of a pollutant is equal to or greater than the pollutant's corresponding locality-specific threshold the second reduced emission operating mode is selected for one or more vehicle organs.

20. The system of claim 19 wherein the processor further comprises a stable memory medium for storing locality-specific pollution data.
